(19) United States
(12) Patent Application Publication
(10) Pub. No.: US 2026/0348791 A1
(43) Pub. Date: Nov. 5, 2026

(54) LENSMETER AND METHOD OF MEASURING LENSES

(71) Applicant: THE HONG KONG POLYTECHNIC UNIVERSITY, Hong Kong (CN)

(72) Inventors: Chi Wai DO, Hong Kong (CN); Wing Fai WONG, Hong Kong (CN); Yujun FU, Hong Kong (CN); Xinwei ZHAI, Hong Kong (CN); Ki Fung CHENG, Hong Kong (CN); Chi Fung NGAN, Hong Kong (CN); Hing Yi LI, Hong Kong (CN); Lily Yee Lai CHAN, Hong Kong (CN)

(21) Appl. No.: 19/576,137

(22) Filed: Mar. 24, 2026

(30) Foreign Application Priority Data
Apr. 30, 2025 (CN) 202510583101.4

(51) Int. Cl. G01M 11/02

(52) U.S. Cl. CPC G01M 11/0214; G01M 11/0264

(57) ABSTRACT

The present application provides a lensmeter and a method of measuring lens optical properties. The lensmeter includes a platform body, provided with a light-shielding cavity, a placement stage configured for placing a lens to be tested, and a placement platform configured for placing an electronic device; the placement stage is provided with a light-transmitting hole communicating with the light-shielding cavity; a test plate, disposed within the light-shielding cavity, in which the placement platform is provided with a through hole, the through hole is configured to allow a camera on the electronic device to capture an image of the test plate through the lens to be tested and the light-transmitting hole; and a light source, mounted on the platform body, in which the light source is located on a side of the test plate away from the light-transmitting hole.

### CROSS REFERENCE TO RELATED APPLICATION

The present application claims priority of a Chinese patent application, with application No. 202510583101.4, filed on Apr. 30, 2025; the contents of which are incorporated into the present application by reference.

### TECHNICAL FIELD

The present application relates to the technical field of lens measuring devices, and more specifically to a lensmeter or lensometer or focimeter and a method of measuring lenses.

### BACKGROUND

Lensmeters are used to measure the optical characteristics of lenses, including spherical power, cylindrical power, axis orientation, etc.) and verify whether the lenses meet prescription standards. They are core devices in the ophthalmology and vision care industries.

Currently, lensmeters on the market are mainly divided into manual lensmeters and digital lensmeters. Manual lensmeters use high-precision optical glass components and rigid metal frameworks, making them bulky and heavy, and difficult to carry. The manual lensmeters rely on manual focusing and reading, requiring professional training for correct use, and non-professionals are prone to measurement errors. Digital lensmeters are similar to manual models, but are also large in size and mainly suitable for fixed locations such as optical shops or hospitals.

### SUMMARY

The objective of the embodiments of the present application is to provide a lensmeter and a method of measuring lens to solve the technical problems of bulky, inconvenient-to-carry, and complex-to-operate of the lensmeter in the prior art.

In order to achieve the above objective, the technical solution adopted in the present application is providing a lensmeter, which includes:
a platform body, provided with a light-shielding cavity, a placement stage configured for placing a lens to be tested, and a placement platform configured for placing an electronic device; the placement stage is provided with a light-transmitting hole communicating with the light-shielding cavity;
a test plate, disposed within the light-shielding cavity, in which the placement platform is provided with a through hole, the through hole is configured to allow a camera on the electronic device to capture an image of the test plate through the lens to be tested and the light-transmitting hole; and
a light source, mounted on the platform body, in which the light source is located on a side of the test plate away from the light-transmitting hole.

Optionally, the lensmeter further includes a pressing head, the pressing head is being mounted on the platform body so as to be movable, thereby fixing the lens to be tested on the placement stage.

Optionally, the pressing head includes a nut, the platform body is provided with a connecting post, the through hole penetrates through the connecting post, and the nut is threadedly engaged with the connecting post.

Optionally, the lensmeter further includes a protective pad, the protective pad is disposed on the placement stage configured for supporting a side of the lens to be tested facing the test plate.

Optionally, the platform body is provided with a positioning groove configured to position the electronic device, and a fixing element is provided at a groove bottom of the positioning groove, and the fixing element is configured to maintain a relative position of the electronic device and the platform body.

Optionally, the lensmeter further includes a light-diffusing plate, and the light-diffusing plate is disposed in the light-shielding cavity and located between the test plate and the light source.

Optionally, a first limiting groove and a second limiting groove are provided in the light-shielding cavity, and the test plate is engaged in the first limiting groove, and the light-diffusing plate is engaged in the second limiting groove.

Optionally, the lensmeter further includes a cover plate, the light-shielding cavity is provided with an opening, and the cover plate is detachably mounted onto the opening.

The present application also provides a method of measuring lens, using the lensmeter described above. The method includes:
acquiring an image of a test plate captured through the lens to be tested;
inputting the image of the test plate into a lens optical performance testing model to obtain a lens power, a prism power, an optical center, and a photochromic property of the lens to be tested;
determining whether a lens optical center under test is aligned with pupils of human eyes based on the lens optical center and a frame size of a spectacles; and
determining an induced prism power if a lens optical center in the spectacles to be tested does not match a pupil position of the human eyes, to be calculated based on the lens power and the offset position of the optical center to be tested from the pupil position;
the lens optical performance testing model is trained taking the image of the test plate captured through a sample lens as a sample, and taking a lens power, a prism power, an optical center, and a photochromic property of the sample lens as labels.

Optionally, the lens power of the lens to be tested includes at least one of a spherical power, a cylindrical power and an axis orientation.

The beneficial effects of the lensmeter provided in the present application are as follows: compared with the prior art, in the lensmeter of the present application, the lensmeter captures an image of the test plate by means of an electronic device placed on the placement platform, so that it is eliminated the need for complex optical components, the structure is simple and is easy to carry. Based on the image captured by the camera on the electronic device, the lens power, the optical center, and the photochromic property of the lens to be tested can be automatically obtained through analysis and processing, so that the operation is simple and which requires no professional expertise from the operator.

### DESCRIPTION OF DRAWINGS

In order to more clearly illustrate the technical solutions in the embodiments of the present application, the drawings used in the description of the embodiments or the prior art will be briefly introduced below. Obviously, the drawings described below are only some embodiments of the present application. For those skilled in the art, other drawings can be obtained based on these drawings without creative effort.

FIG. 1 is a perspective schematic diagram of a lensmeter provided in an embodiment of the present application;

FIG. 2 is an exploded structural diagram of a lensmeter provided in an embodiment of the present application;

FIG. 3 is a partial structural diagram of a lensmeter provided in an embodiment of the present application;

FIG. 4 is a schematic diagram of cooperation between a lensmeter and an electronic device provided in an embodiment of the present application;

FIG. 5 is an exploded structural diagram of the structures shown in FIG. 4;

FIG. 6 is a scatter plot between a spherical power obtained by a method of measuring lens provided in an embodiment of the present application and a spherical power obtained by a digital lensmeter;

FIG. 7 is a scatter plot between a cylindrical power obtained by a method of measuring lens provided in an embodiment of the present application and a cylindrical power obtained by a digital lensmeter;

FIG. 8 a Bland-Altman diagram between a spherical power obtained using a method of measuring lens provided in the present application and a spherical power obtained using a digital lensmeter for a spherical lens with a refractive index of 1.5;

FIG. 9 is a Bland-Altman diagram between a spherical power obtained using a method of measuring lens provided in the present application and a spherical power obtained using a digital lensmeter for a spherical lens with a refractive index of 1.56;

FIG. 10 a Bland-Altman diagram between a spherical power obtained using a method of measuring lens provided in the present application and a spherical power obtained using a digital lensmeter for a spherical lens with a refractive index of 1.67; and

FIG. 11 shows a Bland-Altman diagram between a cylindrical power obtained using a method of measuring lens provided in the present application and a cylindrical power obtained using a digital lensmeter for a cylindrical lens.

The reference numerals in the figures are as follows:
11—platform body; 111—connecting post; 112—through hole; 113—positioning groove; 114—annular groove; 115—placement stage; 116—placement platform; 117—light-transmitting hole; 12—light source; 121—power supply; 122—switch; 13—test plate; 14—light-shielding cavity; 141—first limiting groove; 142—second limiting groove; 143—engagement groove; 15—magnetic element; 16—pressing head; 161—nut; 17—protective pad; 18—light-diffusing plate; 19—cover plate; 191—locking block; 192—handle; 100—electronic device; 200—lens to be tested.

### DETAILED DESCRIPTION OF EMBODIMENTS

In order to clarify the technical problems to be solved by the present application, technical solutions, and beneficial effects, the following describes the present application in further detail with reference to the accompanying drawings and embodiments. It should be understood that the specific embodiments described herein are merely illustrative of the present application and are not intended to limit the present application.

It should be noted that when an element is referred to as “fixed to” or disposed on” another element, it can be directly or indirectly attached to that other element. When an element is referred to as “connected to” another element, it can be directly or indirectly connected to that other element.

It should be understood that the terms “length,” “width,” “upper,” “lower,” “front,” “rear,” “left,” “right,” “vertical,” “horizontal,” “top,” “bottom,” “inner,” and “outer,” etc., indicating orientation or positional relationships based on the orientation or positional relationships shown in the accompanying drawings, are only for the convenience of describing the present application and simplifying the description, and do not indicate or imply that the device or element referred to must have a specific orientation, or be constructed and operated in a specific orientation, and therefore should not be construed as a limitation of the present application.

Furthermore, the terms “first” and “second” are used for descriptive purposes only and should not be construed as indicating or implying relative importance or implicitly specifying the number of indicated technical features. Thus, a feature defined as “first” or “second” may explicitly or implicitly include one or more of that feature. In the description of the present application, “a plurality of” means two or more, unless otherwise explicitly specified.

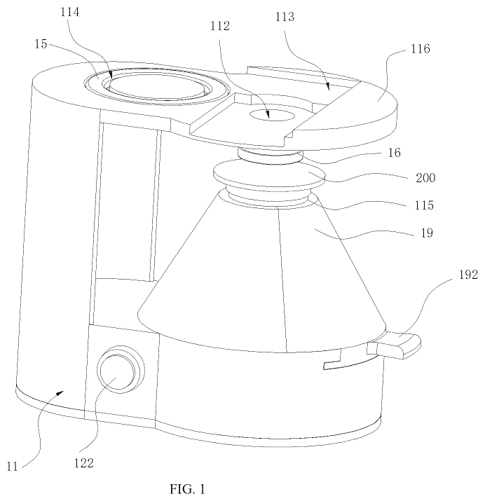

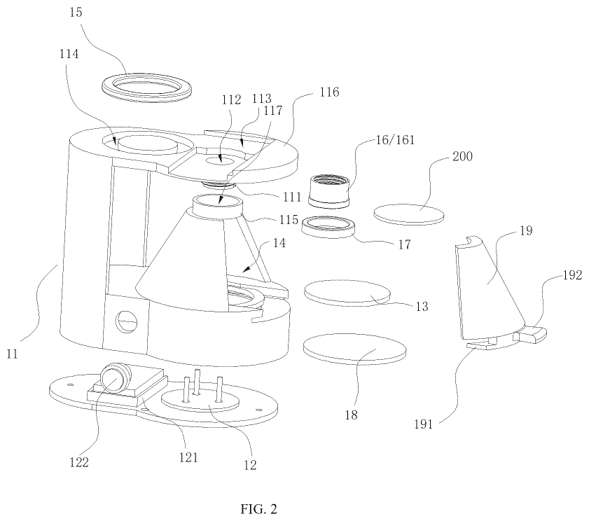

As shown in FIGS. 1 to 11 together, the lensmeter provided in the present application embodiment will now be described. As shown in FIGS. 1 and 2, the lensmeter includes a platform body 11, a light source 12, and a test plate 13. The platform body 11 is provided with a light-shielding cavity 14, and the test plate 13 is mounted within the light-shielding cavity 14. The platform body 11 id provided with a placement stage 115 for placing the lens to be tested 200, and the placement stage 115 is provided with a light-transmitting hole 117 communicating with the light-shielding cavity 14. The light source 12 is disposed on the platform body 11 and located on the side of the test plate 13 opposite to the light-transmitting hole 117. The platform body 11 is also provided with a placement platform 116 for placing an electronic device 100, and the placement platform 116 is provided with a through hole 112. A camera on the electronic device 100 can pass through the through hole 112, the lens to be tested 200, and the light-transmitting hole 117 to capture images of the test plate 13.

The platform body 11 provides a mounting position and a placement position. As shown in FIGS. 1 to 3, the platform body 11 can be placed on a flat table or ground. Optionally, the platform body 11 also includes a base and a column, one end of the column is connected to the base and the other end connected to the placement platform 116. As shown in the figures, the column is located on the same sides of the base and the placement platform 116, so that the platform body 11 is in an U-shaped with its opening facing to the side direction. A protrusion is provided on the side of the base facing the placement platform 116, and the interior of the protrusion is hollow, forming a light-shielding cavity 14. The placement platform 116 is used to place the electronic device 100. As shown in the figures, the protrusion is in a shape of a conical frustum.. It should be noted that the base, the column, and the placement platform 116 can be an integral structure or a part of he base, the column, and the placement platform 116 can be an integral structure.

The test plate 13 is a standard structural member, which is mounted inside the light-shielding cavity 14 to prevent external light from affecting the imaging effect of the test plate 13. The test plate 13 has various types for measuring different optical performance indicators of the lens to be tested 200. For example, when testing the lens power, the test plate 13 is composed of multiple concentric circles or rings of different radii. The test plate 13 can also adopt a high-contrast structure such as a grid board or black background with white lettering. When testing the photochromic performance of the lens to be tested 200, the test plate 13 serves as a color chart; the photochromic performance of the lens to be tested 200 is determined by the color change of the color chart after the light is transmitted through the lens to be tested 200. The light source 12 illuminates the test plate 13 to provide illumination for the camera to capture images of the test plate 13. Optionally, the light source 12 is an LED light panel. As shown in FIGS. 1 and 2, the light-shielding cavity 14 is located between the base and the placement platform 116, and the light source 12 is positioned at the bottom of the light-shielding cavity 14, the light emitted by the light source 12 illuminates on the test plate 13. A power supply 121 is mounted inside the base of the platform body 11, and the power supply 121 is electrically connected to the light source 12 to provide power to the light source 12. Optionally, the power supply 121 is a rechargeable battery, such as a rechargeable lithium battery; or, the power supply 121 is a storage battery. This allows the lensmeter to be used without an external power grid, so that the usage site of the lensmeter is more flexible.

As shown in FIGS. 1 and 2, a switch 122 is provided on the platform body 11, and the switch 122 is electrically connected to the power supply 121. The switch 122 is a knob or a button. The operation of the lensmeter is controlled by the switch 122.

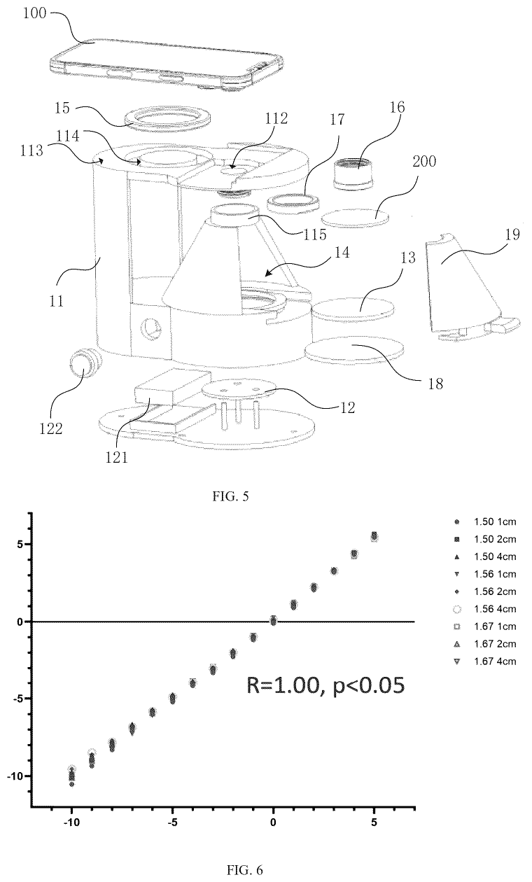

The electronic device 100 is provided with a camera, which is used to capture images of the test plate 13. The electronic device 100 can be fixed to the platform body 11 or detachably mounted on the platform body 11. Specifically, in an optional embodiment, the electronic device 100 includes a camera and a communication unit. The camera is fixed to the platform body 11, and the camera communicates with an external mobile terminal through the communication unit. During the optometry examination, the image of the test plate 13 captured by the camera is transmitted to the external mobile terminal through the communication unit. The external mobile terminal analyzes the image of the test plate 13 to obtain the lens power of the lens to be tested 200. In another optional embodiment, as shown in FIGS. 4 and 5, the electronic device 100 is a mobile device with a camera, such as a mobile phone or a tablet, and the electronic device 100 is detachably connected to the platform body 11. Specifically, the electronic device 100 is provided with a camera and a display screen. When the electronic device 100 is mounted on the platform body 11, the camera on the electronic device 100 can be used to capture images of the test plate 13. After capturing the images, the electronic device 100 analyzes the captured images of the test plate 13 and displays the final lens power on the display screen for user viewing. Alternatively, after capturing the images, the electronic device 100 can communicate with an external mobile terminal, which can then analyze the captured images of the test plate 13. After the lens to be tested is tested, the electronic device 100 is removed from the platform body 11. Thus, the camera is integrated into the electronic device 100, which allows the electronic device 100 and the platform body 11 to be separated, so as to reduce the cost of the lensmeter.

Because the images of the test plate 13 captured by the camera are seen through the lens to be tested 200, the lens power of the lens to be tested 200 can be obtained by analyzing the size changes of the captured images of the test plate 13 compared to the standard image of the test plate 13 in different directions. For example, the lens power of the lens to be tested 200 can be determined based on the size changes of the captured images of the test plate 13 compared to the standard image of the test plate 13 in two vertical directions. In addition, the lens power of the lens to be tested 200 can be determined based on the size changes in three or more directions.

During the lens to be tested is tested, the electronic device 100 is mounted on the platform body 11. Specifically, the electronic device 100 is placed on the placement platform 116. After placement, the camera, the through hole 112, the light-transmitting hole 117, the lens to be tested 200, and the test plate 13 of the electronic device 100 are aligned. The camera is then turned on to capture an image of the test plate 13. In one embodiment, the electronic device 100 directly obtains the lens power of the lens to be tested 200 through image analysis processing based on the captured image of the test plate 13. In another embodiment, the electronic device 100 communicates with an external mobile terminal. For example, the electronic device 100 uploads the captured image of the test plate 13 to a cloud server or other electronic device 100, which then analyzes and processes the image to obtain the lens power information of the lens to be tested 200. Thus, the image analysis and processing of the test plate 13 is performed by the cloud server or other electronic device 100, thereby reducing the energy consumption and configuration requirements of the electronic device 100.

It should be noted that the lens power of the lens to be tested 200 includes one or more of a spherical power, a cylindrical power, and an axis. The spherical power is used to correct myopia, hyperopia, and presbyopia; the cylindrical power is used to correct astigmatism; and the axis orientation is used to specify the direction of astigmatism correction and is used in conjunction with cylindrical power.

The lensmeter provided in the embodiment, compared to traditional lensmeters, the lensmeter captures an image of the test plate 13 by meas of an electronic device 100 placed on the placement platform 116, so that it is eliminated the need for complex optical components, the structure is simple and is easy to carry. Based on the image captured by the camera on the electronic device 100, the lens power, the optical center, and the photochromic property of the lens to be tested 200 can be automatically obtained through analysis and processing, so that the operation is simple and which requires no professional expertise from the operator.

In another embodiment of the present application, as shown in FIGS. 2 and 4, the lensmeter also includes a pressing head 16. The pressing head 16 can be lifted and mounted on the platform body 11. The pressing head 16 is used to press the lens to be tested 200 onto the placement stage 115.

In the embodiment, the pressing head 16 is driven to rise and fall using a linear module or other linear drive mechanism. Alternatively, the pressing head 16 can convert rotation into linear lifting using a threaded structure.

In some optional embodiments, as shown in FIGS. 2 and 4, the pressing head 16 includes a nut 161, and the platform body 11 is provided with a connecting post 111. A through hole 112 passes through the connecting post 111, and the nut 161 is threadedly connected to the connecting post 111. As the nut 161 rotates, the end of the nut 161 can rise and fall.

In further optional embodiments, the pressing head 16 includes an end cap and a rod body. The end cap is fixed to the end of the rod body, and the rod body is threadedly engaged with the platform body 11. In one specific embodiment, the rod body is a hollow column with internal threads. The connecting post 111 protrudes from the platform body 11 towards the placement stage 115, meaning that the connecting post 111 is located on the side of the placement platform 116 facing the placement stage 115. The connecting post 111 is provided with external threads, and the rod body is sleeved over the connecting post 111, allowing the internal and external threads to engage. As the rod body rotates, the end cap moves up and down. After the lens to be tested 200 is placed on the placement stage 115, the rod body is rotated to cause the end cap to move downwards and press against the lens to be tested 200, so as to fix the lens to be tested 200 in place on the placement stage 115. After the lens to be tested 200 is tested, the rod body is rotated in the opposite direction to cause the end cap to move upwards and release the lens to be tested 200, allowing the operator to remove the lens to be tested 200. In another specific embodiment, the rod body is a hollow rod with external threads. The platform body 11 is provided with a connecting post 111 facing the placement stage 115, and the connecting post 111 is provided with internal threads. The rod body is inserted into the connecting post 111 and threadedly engages with the connecting post 111. As the rod body is screwed in, the end cap moves upwards; as the rod body is screwed out, the end cap moves downwards. This linear movement of the end cap is achieved through the threaded connection between the rod body and the connecting post 111. It should be noted that the end cap is made of flexible materials such as silicone or rubber to prevent scratching the lens to be tested 200 during the pressing process. It should be noted that, the connecting post 111, after being connected to the rod body, is provided with a through hole 112 for camera imaging. The through hole 112 corresponds to the light-transmitting hole 117, so as to ensure that the camera can capture images of the test plate 13 through the lens to be tested 200.

In some optional embodiments, the pressing head 16 includes multiple pressure feet arranged in a circumferential pattern. As the pressing head 16 moves, the pressure feet press against the lens to be tested 200.

In the lensmeter provided in the present application, the pressing head 16 is provided to fix the lens to be tested 200, so as to avoid the lens to be tested 200 from moving on the placement stage 115 due to external vibration, thus improving the accuracy of the images of the test plate 13 captured by the camera. Specifically, the nut 161 is threadedly connected to the connecting post 111, enabling the nut 161 to rise and fall. The end face of the nut 161 presses and fixes the lens to be tested 200, eliminating the need for an electric or pneumatic drive mechanism. This results in a simple structure, low cost, and easy portability.

In another embodiment of the present application, as shown in FIGS. 2 and 4, the lensmeter further includes a protective pad 17, the protective pad 17 is disposed on the placement stage 115 and serves to abut against the side of the lens to be tested 200 facing the test plate 13.

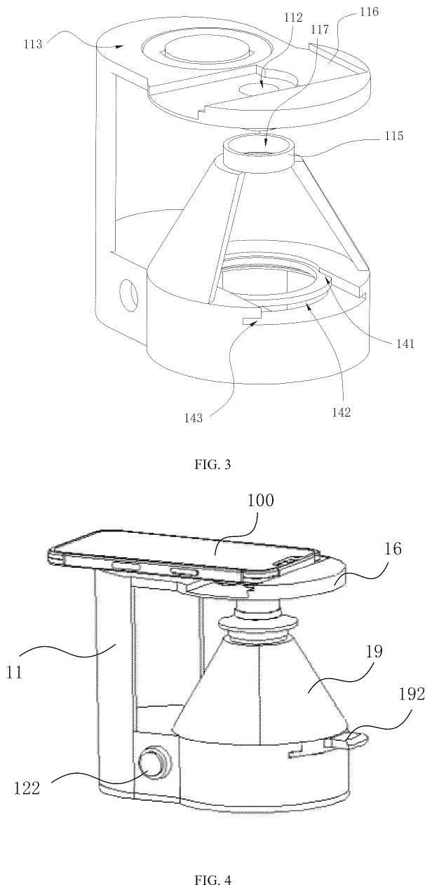

As shown in FIG. 3, the placement stage 115 is annular and protruded at the light-transmitting hole 117. As shown in FIGS. 1 and 2, the protective pad 17 is annular and fitted onto the placement stage 115. After the lens to be tested 200 is placed on the placement stage 115, the protective pad 17 contacts the side of the lens to be tested 200 facing the test plate 13, preventing the placement stage 115 from scratching the lens to be tested 200. Optionally, the protective pad 17 is made of thermoplastic polyurethanes (TPU), which is wear-resistant and has good elasticity.

In another embodiment of the present application, the platform body 11 is provided with a positioning groove 113, and the positioning groove 113 is used to position the electronic device 100. A magnetic element 15 is embedded in the bottom of the positioning groove 113, and the magnetic element 15 is used to fix the relative position of the electronic device 100 and the platform body 11.

Specifically, the positioning groove 113 is provided on the placement platform 116. Optionally, the positioning groove 113 has circumferential sidewalls. Taking the electronic device 100 as a mobile phone as an example, the positioning groove 113 is a square groove, and the SIM card is mounted in the positioning groove 113. In order to accommodate electronic devices 100 of different sizes, the positioning groove 113 has only two groove walls, and the two groove walls are perpendicular to each other. The two groove walls are used to limit the adjacent sides of the electronic device 100 to position the electronic device 100.

If the camera in the electronic device 100 is rear-mounted, there may be a protrusion on the back of the electronic device 100. In a specific embodiment, the bottom of the positioning groove 113 is provided with a groove body that cooperates with the protrusion, so as to provide an accommodating space for the camera protruded and rear-mounted by means of the groove body.

In order to ensure the stability of the electronic device 100 within the specially designed positioning groove 113, a magnetic element or fixture clip 15 is embedded at the bottom of the positioning groove 113. The magnetic element or fixture clip 15 magnetically engages with the housing of the electronic device 100, so as to keep the relative position of the electronic device 100 and the platform body 11 from moving and rotating. Specifically, as shown in FIGS. 1 to 3, an annular groove 114 is provided on the side of the placement platform 116 of the platform body 11 facing away from the test plate 13, and the magnetic element 15 is fitted into the annular groove 114. Specifically, the thickness of the magnetic element 15 does not exceed the depth of the annular groove 114 to avoid obstructing the placement of the electronic device 100 within the positioning groove 113. Optionally, the thickness of the magnetic element 15 is the same as the depth of the annular groove 114, so that when the electronic device 100 is placed in the positioning groove 113, the magnetic element 15 directly contacts the housing of the electronic device 100.

In another embodiment of the present application, as shown in FIGS. 2 and 5, the lensmeter further includes a light-diffusing plate 18, and the light-diffusing plate 18 is disposed within the light-shielding cavity 14 and located between the test plate 13 and the light source 12. The light-diffusing plate 18 has a high light transmittance. By placing the light-diffusing plate 18 between the test plate 13 and the light source 12, the uniformity of illumination from the light source 12 is improved.

In a specific embodiment, as shown in FIG. 3, the light-shielding cavity 14 is provided with a first limiting groove 141 and a second limiting groove 142. The test plate 13 is fitted into the first limiting groove 141, and the light-diffusing plate 18 is fitted into the second limiting groove 142.

Specifically, the first limiting groove 141 and the second limiting groove 142 are arranged around the inner wall of the light-shielding cavity 14. The test plate 13 and the light-diffusing plate 18 are inserted from the side of the light-shielding cavity 14. The test plate 13 is constrained in the vertical direction by the opposite side wall of the first limiting groove 141, and the light-diffusing plate 18 is constrained in the vertical direction by the opposite side wall of the second limiting groove 142. Alternatively, the first limiting groove 141 and the second limiting groove 142 can also be arc-shaped grooves, as long as they can fix the light-diffusing plate 18 and the test plate 13.

The lensmeter provided in the present application uses the first limiting groove 141 and the second limiting groove 142 to fix the test plate 13 and the light-diffusing plate 18, so as to prevent the test plate 13 and the light-diffusing plate 18 from shaking within the light-shielding cavity 14. Furthermore, the snap-fit fixing method for the test plate 13 and the light-diffusing plate 18 facilitates maintenance and replacement of the test plate 13 and the light-diffusing plate 18.

In an optional embodiment, as shown in FIGS. 1, 2, 4, and 5, the lensmeter further includes a cover plate 19. The side of the light-shielding cavity 14 is provided with an opening, and the cover plate 19 is detachably mounted in the opening.

The cover plate 19 is a light-shielding plate, and when the cover plate 19 closes to the opening, the cover plate 19 blocks external light from entering the light-shielding cavity 14. When the cover plate 19 is mounted at the opening, the outer wall of the cover plate 19 smoothly transitions with the outer wall of the light-shielding cavity 14. As shown in FIGS. 2 and 5, the opening facilitates fixing the test plate 13 and the light-diffusing plate 18 within the light-shielding cavity 14. When the cover plate 19 is opened, the test plate 13 and the light-diffusing plate 18 can be repaired and replaced through the opening. In an optional embodiment, one of the walls of the cover plate 19 and the light-shielding cavity 14 is provided with a locking block 191, and the other is provided with an engagement groove 143. The locking block 191 is engaged in the engagement groove 143, and the cover plate 19 can be detachably mounted at the opening by means of the cooperation between the locking block 191 and the engagement groove 143. As shown in FIG. 2, the cover plate 19 is provided with two locking blocks 191, and correspondingly, the wall of the light-shielding cavity 14 is provided with two engagement grooves 143 at the opening. The two locking blocks 191 and the two engagement grooves 143 are engaged in a one-to-one engagement. Optionally, the engagement grooves 143 communicate with the opening to form an irregular opening, and the shape of the cover plate 19 is adapted to the irregular opening.

As shown in FIGS. 2 and 5, the cover plate 19 is provided with a handle 192 to facilitate disassembly of the cover plate 19. When disassembly is required, the cover plate 19 can be removed from the platform body 11 by pulling outwards the handle 192.

In order to facilitate the testing of the photochromic property of the lens to be tested 200, an ultraviolet lamp is mounted on the placement platform 116. During use, the ultraviolet lamp is turned on, and the emitted ultraviolet light passes through the lens to be tested 200 and illuminates the test plate 13, which may be a reference lens. An electronic device captures an image of the test plate or reference lens 13, and the ultraviolet photochromic property of the lens to be tested 200 can be determined based on the comparison of the images of the test plate or changes in the reference lens 13 before and after the ultraviolet lamp is turned on.

The present application also provides a method of measuring lens applying the lensmeter described above. The method includes acquiring an image of a test plate 13 captured through a lens to be tested 200; inputting the image of the test plate 13 into a lens optical performance testing model to obtain a lens power, a prism power, an optical center, and a photochromic property of the lens to be tested 200.

Based on the optical center of the lens to be tested 200 and the frame size of the spectacles to be tested, the fit between the optical center of the lens in the spectacles to be tested and the human pupil is determined. If the optical center of the lens in the spectacles to be tested does not match the human pupil, the induced prism power of the spectacles to be tested is determined based on the optical center of the lens to be tested and lens power of the lens to be tested.

The lens optical performance testing model is trained using images of the test plate 13 captured by a camera through a sample lens as samples, and the lens power, the prism power, the optical center, and the photochromic property of the sample lenses as labels.

Sample lenses include standard lenses and historically tested lenses. Standard lenses are those lenses with known and standardized power, prism power, optical center, and photochromic property. Historically tested lenses are those lenses based on historical data from the lens to be tested 200 tested by the lensmeter. The lens optical performance testing model is continuously optimized through machine learning to improve testing accuracy.

The electronic device 100 is placed on the lensmeter. An image of the test plate 13 is captured by a camera on the electronic device 100. Based on the obtained image of the test plate 13, the lens power, the prism power, the optical center, and the photochromic property of the lens to be tested 200 are obtained, thereby evaluating the performance parameters of the lens to be tested 200 and their compatibility with user needs, and comprehensively assessing the quality of the lens to be tested 200.

Based on the obtained image of the test plate 13, the optical center of the lens to be tested 200 is determined. Combined with the frame size of the spectacles to be tested, the compatibility between the optical center of the lens in the spectacles and the human pupil is determined. The human pupil detection data has already been measured during the spectacles fitting process; the frame size of the spectacles to be tested is obtained through manual input or analysis of images of the spectacles captured by the camera.

The induced prism power is used to assess whether the frame needs adjustment or reprocessing. If the optical center of the lens of the spectacles to be tested does not match the pupil of the human eye, the induced prism power is calculated based on the formula P=F×C, where P is the induced prism power, F is the refractive power of the lens (i.e., the lens power), and C is the distance from the pupil of the human eye to the optical center.

An APP is built into the electronic device 100 or an external mobile terminal, the APP runs the method of measuring lens described above. Thus, after the camera captures an image of the test plate 13 through the lens to be tested 200, the electronic device 100 or external mobile terminal can automatically obtain the lens power, the prism power, the optical center, and the photochromic property, and determine the fit between the spectacles to be tested and the pupil of the human eye, thereby determining whether the frame needs adjustment. This helps users determine whether the spectacles to be tested match the prescription requirements, and the method is simple and efficient.

In order to test the effectiveness of the method of measuring lens provided in the present application, the following explanation uses the accuracy of the lens power obtained using the method of measuring lens provided in the present application as an example. The lens power obtained by the above-described method of measuring lens was compared with the lens power obtained using a digital lensmeter (NIDEK LM-1800PD). Specifically, the accuracy of the lens power was evaluated using spherical lenses with different refractive indices (1.50, 1.56, and 1.67) ranging from −10.00 D to +5.00 D (with 1 D as the horizontal axis interval) and cylindrical lenses with a refractive index of 1.53 (−1.00 DC to −5.00 DC, with 1 DC as the horizontal axis interval and an axial angle of 90°).

FIG. 6 shows the results of comparing the spherical power obtained by the method of measuring lens provided in the present application with the spherical power obtained by the digital lensmeter at different refractive indices, with the horizontal axis ranging from −10.00 D to +5.00 D. In FIG. 6, the horizontal axis represents the spherical power measured by the digital lensmeter, and the vertical axis represents the spherical power obtained using the lensmeter and the method of measuring lens provided in the present application. Statistical analysis shows that for spherical lenses, the correlation between the spherical power obtained using the lensmeter and the digital lensmeter provided in the present application is R=1.00, p<0.05. This indicates that there is no significant difference between the spherical power obtained by the method of measuring lens provided in the present application and the spherical power obtained by the digital lensmeter. The mean difference test shows p=0.84, t=1.97, indicating that there is no statistically significant difference between the spherical power obtained by the method of measuring lens provided in the present application and the spherical power obtained by the digital lensmeter.

For cylindrical lenses with a refractive index of 1.53, ranging from −1.00 DC to −5.00 DC, with 1 DC as the horizontal axis interval, and an axial angle of 90°, the lens power obtained by the method of measuring lens provided in the present application and the cylindrical power obtained by the digital lensmeter are shown in FIG. 7. In FIG. 7, the horizontal axis represents the cylindrical power measured using the digital lensmeter, and the vertical axis represents the cylindrical power obtained using the lensmeter and the method of measuring lens provided in the present application. Statistical correlation analysis showed that the correlation between the lens power of cylindrical lenses was R=1.00, p<0.05. The mean difference test showed p=0.81, t=2.06. Therefore, the cylindrical power obtained by the method of measuring lens provided in the present application is highly consistent with the cylindrical power obtained by the digital lensmeter, and there is no statistically significant difference.

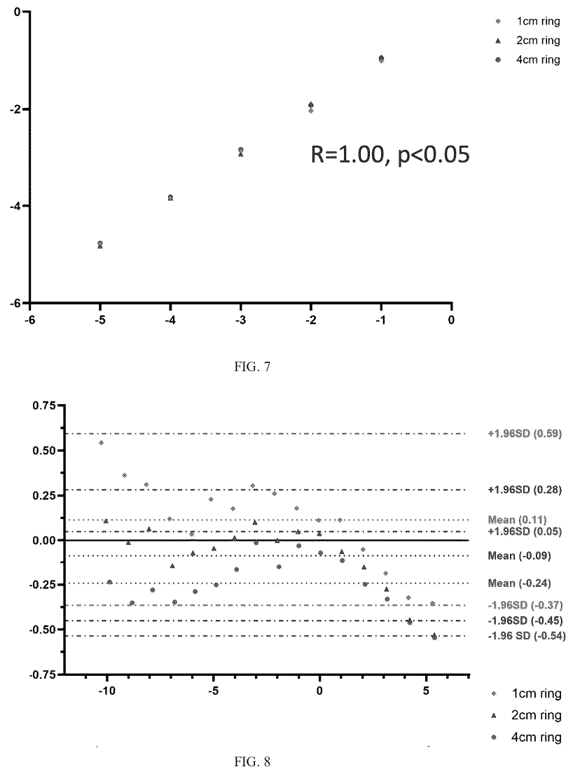

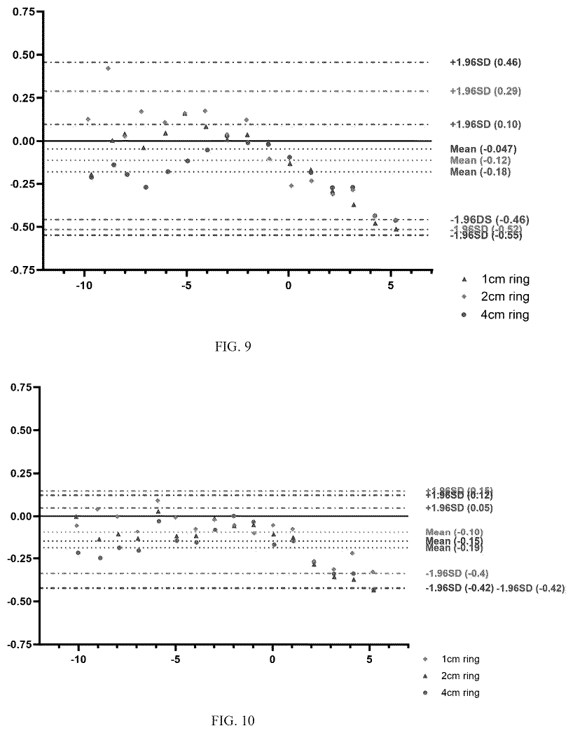

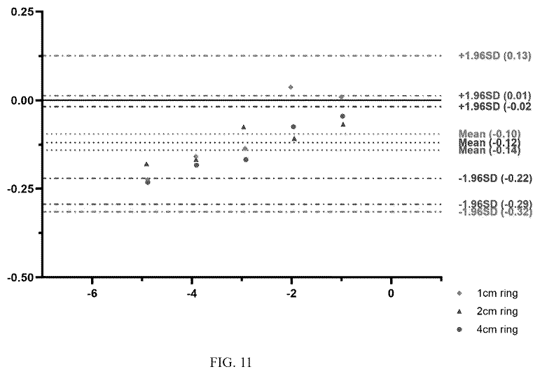

As shown in FIGS. 8 to 11, the horizontal axis represents the average value of the method of measuring lens provided in the present application and the measurement method using a digital lensmeter, and the vertical axis represents the difference between the two measurement methods.. FIG. 8 shows a spherical lens with a refractive index of 1.5 ranging from −10.00 D to +5.00 D; FIG. 9 shows a spherical lens with a refractive index of 1.56 ranging from −10.00 D to +5.00 D; FIG. 10 shows a spherical lens with a refractive index of 1.67 ranging from −10.00 D to +5.00 D; and FIG. 11 shows a cylindrical lens with a refractive index of 1.53 and an axial angle of 90° ranging from −1.00 DC to −5.00 DC. As shown in FIGS. 8, 9, and 10, the mean absolute error (MAE) of spherical lenses is 0.18±0.14 D (positive lens: 0.30±0.13 D; negative lens: 0.12±0.11 D). Approximately 70% of the measurements for spherical lenses are within ±0.25 D, and 100% of the measurements are within ±0.50 D. The MAE of spherical lenses varies slightly with refractive index: when the refractive index is 1.50, the MAE is 0.20±0.15 D; when the refractive index is 1.56, the MAE is 0.19±0.15 D; and when the refractive index is 1.67, the MAE is 0.15±0.12 D. FIG. 11 shows that the MAE of cylindrical lenses is 0.12±0.07 DC, and all measurements (100%) for cylindrical lenses are within ±0.25 DC. Therefore, both spherical and cylindrical lenses exhibit no consistent deviation and demonstrate good consistency.

The method of measuring lens provided in the present application uses a machine learning-based model training approach. By inputting the image of the test plate 13 captured by a camera into the lens optical performance testing model, the lens power, the prism power, the optical center, and the photochromic property of the lens to be tested 200 can be obtained. Verified with a traditional digital lensmeter, the output lens power is highly accurate. Furthermore, the lensmeter used has a simple structure, is portable, and easy to operate, requiring no professional training. It facilitates the determination of whether the lens to be tested and the spectacles to be tested match the prescription requirements.

The above description is merely a preferred embodiment of the present application and is not intended to limit the present application. Any modifications, equivalent substitutions, and improvements made within the spirit and principles of the present application should be included within the scope of protection of the present application.

What is claimed is:

1. A lensmeter, comprising:
a platform body (11), provided with a light-shielding cavity (14), a placement stage (115) configured for placing a lens to be tested (200), and a placement platform (116) configured for placing an electronic device (100); wherein the placement stage (115) is provided with a light-transmitting hole (117) communicating with the light-shielding cavity (14);
a test plate (13), disposed within the light-shielding cavity (14), wherein the placement platform (116) is provided with a through hole (112), the through hole (112) is configured to allow a camera on the electronic device (100) to capture an image of the test plate (13) through the lens to be tested (200) and the light-transmitting hole (117); and
a light source (12), mounted on the platform body (11), wherein the light source (12) is located on a side of the test plate (13) away from the light-transmitting hole (117).

2. The lensmeter according to claim 1, wherein the lensmeter further comprises a pressing head (16), the pressing head (16) being mounted on the platform body (11) so as to be movable, thereby fixing the lens to be tested (200) on the placement stage (115).

3. The lensmeter according to claim 2, wherein the pressing head (16) comprises a nut (161), the platform body (11) is provided with a connecting post (111), the through hole (112) penetrates through the connecting post (111), and the nut (161) is threadedly engaged with the connecting post (111).

4. The lensmeter according to claim 1, wherein the lensmeter further comprises a protective pad (17), the protective pad (17) is disposed on the placement stage (115) configured for supporting a side of the lens to be tested (200) facing the test plate (13).

5. The lensmeter according to claim 1, wherein the platform body (11) is provided with a positioning groove (113), the positioning groove (113) is configured to position the electronic device (100), a fixing element (15) is provided at a groove bottom of the positioning groove (113), and the fixing element (15) is configured to maintain a relative position of the electronic device (100) and the platform body (11).

6. The lensmeter according to claim 1, wherein the lensmeter further comprises a light-diffusing plate (18), and the light-diffusing plate (18) is disposed in the light-shielding cavity (14) and located between the test plate (13) and the light source (12).

7. The lensmeter according to claim 6, wherein a first limiting groove (141) and a second limiting groove (142) are provided in the light-shielding cavity (14), the test plate (13) is engaged in the first limiting groove (141), and the light-diffusing plate

(18) is engaged in the second limiting groove (142).

8. The lensmeter according to claim 1, wherein the lensmeter further comprises a cover plate (19), the light-shielding cavity (14) is provided with an opening, and the cover plate (19) is detachably mounted onto the opening.

9. A method of measuring lens, using a lensmeter according to claim 1, wherein the method comprises:
acquiring an image of a test plate (13) captured through the lens to be tested (200);
inputting the image of the test plate (13) into a lens optical performance testing model to obtain a lens power, a prism power, an optical center, and a photochromic property of the lens to be tested (200);
determining whether a lens optical center (200) under test is aligned with pupils of human eyes based on the lens optical center and a frame size of the spectacles; and
determining an induced prism power if a lens optical center in the spectacles to be tested does not match a pupil position of the human eyes, to be calculated based on the lens power and an offset position of the optical center to be tested (200) from the pupil position;
wherein the lens optical performance testing model is trained taking the image of the test plate (13) captured through a sample lens as a sample, and taking a lens power, a prism power, an optical center, and a photochromic property of the sample lens as labels.

10. The method of measuring lens according to claim 9, wherein the lens power of the lens to be tested (200) comprises at least one of a spherical power, a cylindrical power and an axis orientation.

11. The method of measuring lens according to claim 9, wherein the lensmeter further comprises a pressing head (16), the pressing head (16) is liftable mounted on the platform body (11) to fix the lens to be tested (200) on the placement stage (115).

12. The method of measuring lens according to claim 11, wherein the pressing head (16) comprises a nut (161), the platform body (11) is provided with a connecting post (111), the through hole (112) penetrates through the connecting post (111), and the nut (161) is threadedly engaged with the connecting post (111).

13. The method of measuring lens according to claim 11, wherein the lensmeter further comprises a protective pad (17), the protective pad (17) is disposed on the placement stage (115) configured for supporting a side of the lens to be tested (200) facing the test plate (13).

14. The method of measuring lens according to claim 11, wherein the platform body (11) is provided with a positioning groove (113), the positioning groove (113) is configured to position the electronic device (100), a fixing element (15) is embedded in a groove bottom of the positioning groove (113), and the fixing element (15) is configured to maintain a relative position of the electronic device (100) and the platform body (11).

15. The method of measuring lens according to claim 11, wherein the lensmeter further comprises a light-diffusing plate (18), and the light-diffusing plate (18) is disposed in the light-shielding cavity (14) and located between the test plate (13) and the light source (12).

16. The method of measuring lens according to claim 15, wherein a first limiting groove (141) and a second limiting groove (142) are provided in the light-shielding cavity (14), the test plate (13) is engaged in the first limiting groove (141), and the light-diffusing plate (18) is engaged in the second limiting groove (142).

17. The method of measuring lens according to claim 11, wherein the lensmeter further comprises a cover plate (19), the light-shielding cavity (14) is provided with an opening, and the cover plate (19) is detachably mounted onto the opening.
